(19) United States
(12) Patent Application Publication
(10) Pub. No.: US 2008/0110787 A1
(43) Pub. Date: May 15, 2008

(54) SHEET OF PAPER, ESPECIALLY A CUTLERY POUCH

(76) Inventor: Lothar Hummerich, Harschbach (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/839,083

(22) Filed: Aug. 15, 2007

(30) Foreign Application Priority Data
Nov. 10, 2006 (DE) 20 2006 017 180

(51) Int. Cl. B31D 1/04; A47G 11/00

(52) U.S. Cl. 206/494; 493/405

(57) ABSTRACT

An apparatus for creating a pocket structure includes a sheet configured to be folded upon itself such that a first panel of the sheet is disposed over one or more remaining panels of the sheet. A punched out portion is included in the first panel. The punched out portion may have a semi-circular, triangular, or rectangular shaped contour. The apparatus may further include a tapered out portion of the punched out portion adjacent to an upper edge of the first panel. The punched out portion may be spaced from an upper edge of the first panel by a distance between ⅕ and ⅓ the height of the first panel. The punched out portion may be centrally located between the side edges of the first panel. The sheet may further be configured to be folded along a plurality of folding lines which may be depicted on the sheet.

### CROSS-REFERENCE TO RELATED APPLICATIONS

The present application claims priority to German Application No. 20 2006 017 180, filed Nov. 10, 2006, the entirety of which is incorporated herein by reference.

### TECHNICAL FIELD

The invention pertains to a paper sheet, particularly a napkin, which may be folded several times so as to form a closed pocket, particularly for accommodating articles such as flatware.

### BACKGROUND

DE 20 2005 005 882 U1 describes a napkin that is made of woodpulp, paper or a similar material, wherein the single-layer basic shape is transformed into a multi-layer service shape with the aid of intersecting folding lines.

### SUMMARY

In this case, multiple folds result in a structure having a pocket that is open toward a narrow side and, for example, serves for accommodating an article, e.g., flatware, informative material, etc. The edge of the pocket opening is oriented parallel to and spaced apart from the adjacent napkin edge. In order to form the pocket, a first fold is produced along a first folding line that extends parallel to and lies opposite the napkin edge. Another fold is produced along a folding line that extends centrally and transverse to the first folding line, wherein yet another fold is subsequently produced along a thusly produced second central folding line in order to realize the service shape featuring the pocket.

The invention is based on the objective of developing a visually appealing paper sheet of the initially cited type that can be easily manufactured and handled. According to the invention, this objective is attained by including a punching that serves as an insertion aid in the panel of the paper sheet that forms an outer side of the pocket.

The punching is produced in a dimensionally accurate fashion in the developed paper sheet, i.e., the paper sheet in its original non-folded state, and simplifies the insertion of objects such as, for example, flatware and/or a napkin and/or informative material into the pocket produced by means of multiple folds. Naturally, the paper used may consist of napkin quality paper or a so-called airlaid non-woven fabric such that the paper sheet that serves, in particular, as a flatware pocket can also be used for protection and cleaning purposes during and after a meal in its developed form.

In order to simplify the insertion of objects into the pocket produced by the paper sheet, the punching preferably has a circle, triangular, or rectangular contour. The triangular contour may be configured such that the apex of the triangle situated centrally in reference to the width of the pocket or the face of the pocket assigned to the opening is obliquely cut off over the width of the pocket.

Alternatively the punching may be straight-line or arc-shaped. Having such a punching may simplify the insertion of articles into the pocket. The slot may be formed by a razor cut.

A relatively large pocket opening on the face is realized if the punching is produced such that it is tapered toward the upper edge of the panel. The punching ensures that the user of the folded paper sheet notices that an object is inserted into the pocket because an object of corresponding size that is inserted to a certain depth protrudes into the punching and lies on the panel of the paper sheet that is situated on an inner side of the pocket.

According to an alternative embodiment, the punching is arranged such that it is spaced apart from the upper edge of the panel, in particular, by ⅕ to ⅓ the height of the panel. Objects are inserted into the pocket through the slot and lie on the panel of the paper sheet that forms the outer side of the pocket with their end that protrudes from the pocket. The punching is preferably positioned centrally in reference to the width of the panel.

According to one embodiment, the square paper sheet features a first folding line that is arranged centrally as well as parallel to two of its opposite outer edges in its developed form, wherein a second folding line with the opposite folding direction extends centrally and perpendicular to the first folding line and is divided into equal sections by a third and a fourth folding line that respectively extend perpendicular thereto and have different folding directions such that the paper sheet is divided into a four-by-two matrix with panels of identical size. All folding lines are produced by respectively folding the paper sheet such that its size is reduced by half, wherein this multiple folding process can be realized relatively easily and inexpensively because opposite lateral edges of the paper sheet are always congruently placed on top of one another.

### BRIEF DESCRIPTION OF THE DRAWINGS

While the claims are not limited to the illustrated embodiments, an appreciation of various aspects of the system is best gained through a discussion of various examples thereof. Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limiting or restricting to the precise form and configuration shown in the drawings and disclosed in the following detailed description. Exemplary embodiments of the present invention are described in detail by referring to the drawings as follows.

FIG. 1, illustrates a developed view of an inventive paper sheet;

FIG. 2, illustrates a partially developed view of the paper sheet according to FIG. 1 after a first fold is produced;

FIG. 3, illustrates a partially developed view of the paper sheet according to FIG. 1 after a second fold is produced;

FIG. 4, illustrates a partially developed view of the paper sheet according to FIG. 1 after a fourth fold is produced;

FIG. 5, illustrates an alternative variation of detail V in FIG. 4;

FIG. 6, illustrates a second alternative variation of detail V in FIG. 4;

FIG. 7, illustrates a third alternative variation of the detail V in FIG. 4;

FIG. 8, illustrates another alternative variation of detail V in FIG. 4, and

FIG. 9, illustrates another alternative variation of detail V in FIG. 4.

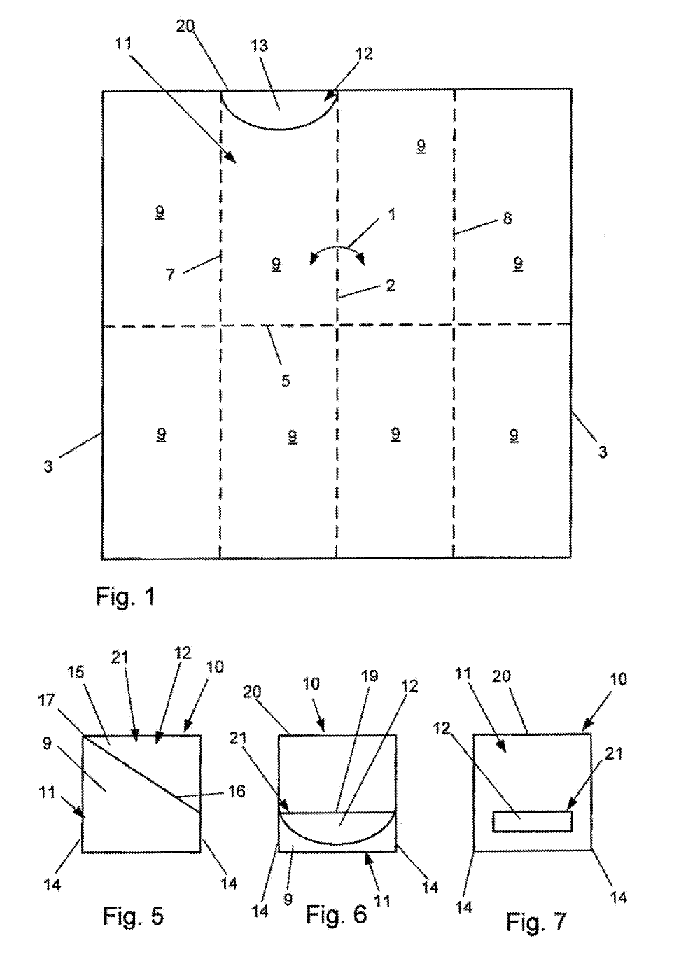

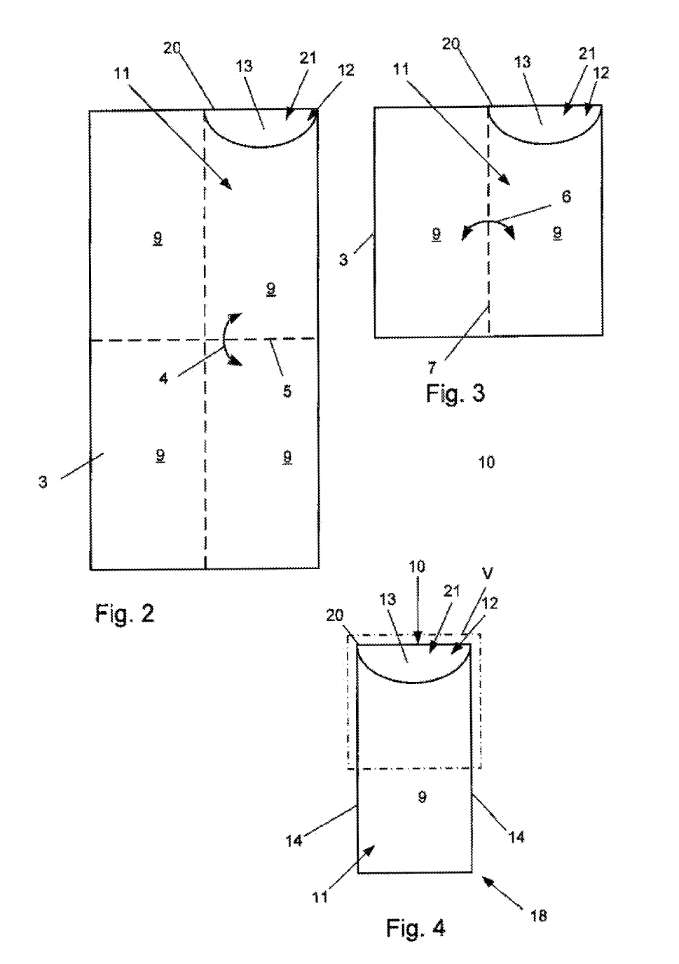

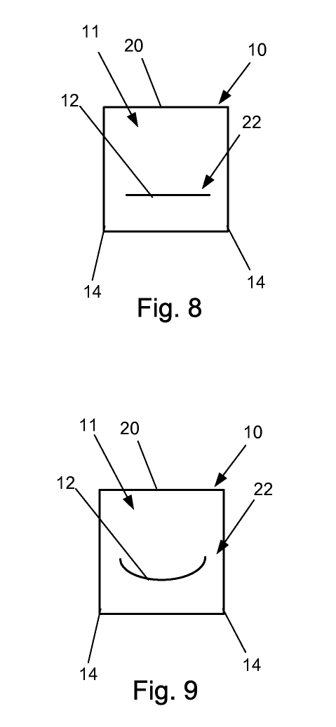

### DETAILED DESCRIPTION

The paper sheet made of a napkin quality material has a square shape in its developed form and is initially folded along a first folding line 2 that extends centrally as well as parallel to two opposite outer edges 3, namely in the direction indicated by the double arrow 1. A second fold is subsequently produced along a second folding line 5 that extends centrally as well as perpendicular to the first folding line 2, namely in the direction indicated by the double arrow 4. Along the second folding line 5, the folding direction on one side of the first folding line 2 extends opposite that on the other side of the first folding line 2 in the developed view. A third fold is produced in the direction indicated by the double arrow 6 and therefore perpendicular to the second folding line 5 along the third folding line 7 and the fourth folding line 8. The surface of the paper sheet is reduced by half with each folding process until the paper sheet is divided into a four-by-two matrix with panels 9 of identical size. After these folds are produced, the paper sheet forms a pocket 18 with an opening 10 on its upper side.

The panel 9 of the paper sheet that forms an outer side 11 of the pocket features a punching 12 that serves as an insertion aid 21 and has the shape of a sector of a circle 13, wherein said punching is arranged on an upper edge 20 of the pocket 18 such that it lies centrally between the narrow sides 14 of the panel 9 and is tapered out toward the opening 10. Alternatively, the punching 12 is realized in the form of a triangle 15, the hypotenuse 16 of which extends from an upper corner 17 of one narrow side 14 to the other narrow side 14 of the pocket 18 at an acute angle. In another alternative embodiment, a straight line 19 of the circle sector-shaped punching 12 is approximately spaced apart from the upper edge 20 by ⅕ the overall height of the pocket 18 and extends from one narrow side 14 of the pocket 18 to the other narrow side 14 in order to form the insertion aid 21. In a last alternative embodiment, the punching 12 has a rectangular shape and is arranged such that it forms an insertion aid 21 that is spaced apart from the upper edge 20 as well as the two narrow sides 14. In another alternative approach punching 12 may be a straight-line 22 between both the upper edge 20 and the two narrow sides 14. In another alternative approach the punching 12 may be an arc 22.

The preceding description has been presented only to illustrate and describe exemplary embodiments of the claimed invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

1. An apparatus, comprising:
a sheet configured to be folded upon itself such that a first panel of the sheet is disposed over one or more remaining panels of the sheet; and
a punched out portion in the first panel.

2. The apparatus of claim 1, wherein the punched out portion has a contour selected from the group consisting of a semi-circular shape, a triangular shape, and a rectangular shape.

3. The apparatus of claim 1, further comprising a tapered out portion of the punched out portion adjacent to an upper edge of the first panel.

4. The apparatus of claim 1, wherein the punched out portion is spaced from an upper edge of the first panel by a distance between ⅕ and ⅓ the height of the first panel.

5. The apparatus of claim 1, wherein the punched out portion is centrally located between first and second side edges of the first panel.

6. The apparatus of claim 1, wherein the sheet is further configured to be folded along a plurality of folding lines.

7. The apparatus of claim 1, further comprising a plurality of folding lines depicted on the sheet.

8. The apparatus of claim 1, wherein the sheet has a square shape, and further comprising:
a first folding line extending parallel to an edge of the sheet such that the sheet is evenly divided in to a first and second half,
a second folding line extending parallel to the first folding line such that the first half is evenly divided into a first and second quarter;
a third folding line extending parallel to the first folding line such that the second half is evenly divided into a third and fourth quarter; and
a fourth folding line extending perpendicularly to the first folding line such that the first, second, third, and fourth quarters are evenly divided the first panel and the one or more remaining panels.

9. A pocket structure, comprising:
a sheet configured to be folded upon itself along a plurality of folding lines;
a plurality of layers, the layers including
an outer layer; and
a plurality of sub-layers disposed under the outer layer, wherein the plurality of layers being formed by the sheet being folded along the plurality of folding lines;
a plurality of closed edges formed along the folding lines;
a plurality of voids, each void enclosed by sequential layers of the plurality of layers and the plurality of closed edges; and
a punched out portion disposed on the outer layer.

10. A method of producing a pocket structure from a sheet, comprising
forming the sheet into an outer layer and a plurality of sub-layers by folding the sheet along a plurality of folding lines; and
including a punched out portion on the outer layer.

11. The apparatus of claim 1 where in the punched out portion is a straight line.

12. The apparatus of claim 1 where in the punched out portion is arc-shaped.
